(19) United States
(12) Patent Application Publication
(10) Pub. No.: US 2022/0414886 A1
(43) Pub. Date: Dec. 29, 2022

(54) SEMANTIC IMAGE SEGMENTATION USING CONTRASTIVE CHANNELS

(71) Applicant: X Development LLC, Mountain View, CA (US)

(72) Inventor: Sarah Ann Laszlo, Mountain View, CA (US)

(21) Appl. No.: 17/360,163

(22) Filed: Jun. 28, 2021

(51) Int. Cl. G06T 7/10; G06K 9/62; G06N 3/08; G06N 3/04

(52) U.S. Cl. CPC G06T 7/10; G06K 9/628; G06N 3/08; G06N 3/0481; G06T 2207/20084; G06T 2207/20081

(57) ABSTRACT

Methods, systems, and apparatus, including computer programs encoded on a computer storage medium, for training a segmentation neural network. In one aspect, a method comprises: obtaining data defining: (i) an image, and (ii) a respective class of each pixel in the image from a set of possible classes; determining a target segmentation of the image that comprises one or more target contrastive channels, wherein each target contrastive channel corresponds to a respective pair of classes including a respective first class and a respective second class from the set of possible classes; and training the segmentation neural network to process the image to generate a predicted segmentation that matches the target segmentation.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a segmentation system implemented as computer programs on one or more computers in one or more locations. The segmentation system is configured to process an image to generate a semantic segmentation of the image that defines a respective class, from a set of possible classes, for each pixel in the image.

The segmentation system described herein is generally applicable and can be used to perform any appropriate semantic segmentation task. For illustrative purposes, a few examples of possible semantic segmentation tasks that can be performed by the system are described in more detail next.

In some implementations, the segmentation system is configured to process a satellite image (i.e., an image captured by a satellite) to generate a semantic segmentation of the satellite image into classes including one or more of: roadway, driveway, water, building, forest, and the like.

In some implementations, the segmentation system is configured to process an image captured by a drone (e.g., an unmanned aerial vehicle) to generate a semantic segmentation of the image into classes including one or more of: vegetation, power line, roadway, vehicle, person, and the like.

In some implementations, the segmentation system is configured to process a medical image, e.g., an image showing tissue in a patient that is captured using a medical imaging modality, e.g., an ultrasound (US) image, a magnetic resonance image (MM), a computed tomography (CT) image, an x-ray image, or a histological image. The segmentation system can process the medical image to generate a semantic segmentation of the organs shown in the medical image, e.g., where the classes include one or more of: liver tissue, prostate tissue, brain tissue, kidney tissue, intestinal tissue, breast tissue, and the like. In some cases, the set of possible classes includes one or more “abnormal” tissue classes, e.g., a class corresponding to cancerous tissue.

In some implementations, the segmentation system is configured to process a photogrammetric image of one or more items, e.g., on an assembly line in a manufacturing environment, to generate a semantic segmentation of the photogrammetric image into a set of classes including a “defect” class. Pixels included in the defect class can correspond to regions of an item where a manufacturing defect is present.

The segmentation system can be implemented in any of a variety of possible locations, e.g., in a data center, or in an onboard system of a device, e.g., a personal digital assistant device, a drone, or a partially or fully autonomous land, sea, or air vehicle.

Semantic segmentations generated by the segmentation system can be used for any of a variety of purposes. For example, the segmentation system can be deployed on a drone to process images captured by a camera on the drone to generate semantic segmentations (e.g., of vegetation, power lines, etc.) which are thereafter provided to a navigation system that controls the flight path of the drone. As another example, the segmentation system can be deployed on an autonomous vehicle to process images captured by a camera of the vehicle to generate semantic segmentations (e.g., of pedestrians, bicyclists, etc.) which are thereafter provided to a planning system that controls the steering and acceleration of the vehicle. As another example, the segmentation system can be deployed as part of a clinical workflow to process medical images of patients to generate semantic segmentations (e.g., or organs and cancerous tissue) which are thereafter used for radiotherapy treatment planning.

Generally, the set of possible classes can include any appropriate number of classes, e.g., 3 classes, 10 classes, 100 classes, or 1000 classes. Throughout this specification, the number of classes in the set of possible classes should be understood as being at least 3 classes. In some implementations, the set of possible classes includes a “default” class that includes any pixel that is not included in any of the other classes.

The segmentation system generates semantic segmentations using a segmentation neural network. The segmentation neural network is configured to process an image, in accordance with values of a set of segmentation neural network parameters, to generate a set of one or more output “channels.” A channel can refer to an ordered collection of “scores” (e.g., numerical values arranged in a 2D array) that includes a respective score corresponding to each pixel in the input image.

Generally, some or all of the output channels generated by the segmentation neural network are “contrastive” channels that each correspond to a respective pair of classes (including a “first” class and a “second” class) from the set of possible classes. Each contrastive channel includes a respective score for each pixel in the image that predicts whether the pixel is included in: (i) the first class corresponding to the contrastive channel, (ii) the second class corresponding to the contrastive channel, or (iii) any class other than the first class and the second class corresponding to the contrastive channel. Put another way, each contrastive channel characterizes a predicted segmentation of the image into respective regions corresponding to: (i) the first class, (ii) the second class, and (iii) any class other than the first class and the second class. Generating contrastive channels that distinguish between multiple classes in a single channel can increase the accuracy of the segmentation neural network while decreasing consumption of computational resources by reducing the number of output channels generated by the segmentation neural network, as will be described in more detail below.

Throughout this specification, an “image” can refer to any appropriate type of image, e.g., a color image (e.g., an RGB image represented by a red channel, a green channel, and a blue channel), a hyperspectral image, or a density image (e.g., as generated by a computed tomography (CT) scanner). An image can be, e.g., a two-dimensional (2D) image, a three-dimensional (3D) image, or more generally, an N-dimensional (N-D) image.

An image can be represented, e.g., as an array of “pixels,” where each pixel is associated with a respective spatial location in the image and corresponds to a respective vector of one or more numerical values representing image data at the spatial location. For example, a 2D RGB image can be represented by a 2D array of pixels, where each pixel is associated with a respective 3D vector of values representing the intensity of red, green, and blue color at the spatial location corresponding to the pixel in the image.

Throughout this specification, a “neural network” refers to an artificial neural network, i.e., that is implemented by one or more computers. A “sub-network” refers to a neural network that is included in another, larger neural network.

Particular embodiments of the subject matter described in this specification can be implemented so as to realize one or more of the following advantages.

This specification describes a training system for training a segmentation neural network that can be used, e.g., to generate a semantic segmentation of the pixels of an image into a set of possible classes. The training system trains the segmentation neural network to process an image to generate a segmentation of the image that includes “contrastive” channels that each correspond to a respective first class and a respective second class from the set of possible classes. Each contrastive channel includes a respective score for each pixel in the image that defines whether the pixel is included in: (i) the first class, (ii) the second class, or (iii) any class other than the first class or the second class. Contrastive channels differ from, e.g., conventional “single class” channels that each correspond to a respective single class and that include a respective score for each pixel in the image that defines whether or not the pixel is included in the single class.

Generating contrastive channels (rather than, e.g., single class channels) can reduce the number of output channels generated by the segmentation neural network, in some cases, by up to half, or by more than half (e.g., in some cases, the number of output channels can be reduced to log₂N, where N is the number of possible classes). For example, rather than generating 100 single class channels, the training system can train the segmentation neural network to generate 50 contrastive channels. Thus generating contrastive channels can reduce consumption of computational resources by reducing the architectural complexity of the segmentation neural network and by reducing the memory and computing power required to store and process the output channels generated by the segmentation neural network.

Moreover, training the segmentation neural network to generate contrastive channels can improve the prediction accuracy of the segmentation neural network. In particular, generating a contrastive channel requires the segmentation neural network to generate informative internal representations of an input image (e.g., in the hidden layers of the segmentation neural network) to simultaneously distinguish between multiple classes in a single channel. Put another way, learning to generate a contrastive channel trains the segmentation neural network to identify the features of a first class by directly contrasting the features of the first class with those of a second class, and vice versa. Learning to generate a contrastive channel thereby enables the segmentation neural network to discover the most relevant features for distinguishing each class from each other class, thereby improving prediction accuracy.

The segmentation neural network can include a “brain emulation” sub-network having an architecture and parameter values that are based on synaptic connectivity between biological neurons in a brain of a biological organism. The brains of biological organisms may be adapted by evolutionary pressures to be effective at segmenting images, and including a brain emulation sub-network in the segmentation neural network allows the segmentation neural network to harness this capacity to effectively segment images. Segmentation neural networks that include brain emulation sub-networks may require less training data, fewer training iterations, or both, to achieve an acceptable prediction accuracy in performing semantic segmentation tasks than other neural networks, i.e., that do not include brain emulation sub-networks. Moreover, including a brain emulation sub-network in a segmentation neural network can allow the segmentation neural network to achieve a higher segmentation accuracy than would otherwise be possible, i.e., without the brain emulation sub-network.

Training the segmentation neural network to generate contrastive channels aligns the learning strategy of the segmentation neural network more closely with that of biological organisms in the real world, e.g., that learn to distinguish different classes by contrasting them with one another. Thus training the segmentation neural network to generate contrastive channels can be particularly effective for improving the performance of segmentation neural networks that include brain emulation sub-networks.

Training the segmentation neural network to generate contrastive channels can facilitate generating accurate segmentations of “difficult” classes that are easily misclassified, e.g., classes that are characterized by ambiguous features or that include only a small number of pixels. In particular, a class that is designated as a difficult class can be included in multiple contrastive channels, e.g., enabling the segmentation neural network to learn to distinguish the difficult class relative to each of multiple other classes and thus allowing the segmentation neural network to learn more discriminative features for the difficult class.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example training system.

FIG. 2 provides an illustration of an example of a target contrastive channel.

FIG. 3 illustrates an example where a training system generates three target contrastive channels corresponding to a set of four possible classes.

FIG. 4 illustrates an example where a training system generates two contrastive channels corresponding to a set of four possible classes.

FIG. 5 shows an example segmentation system.

FIG. 6 is a flow diagram of an example process for training a segmentation neural network.

FIG. 7 shows an example data flow for determining an architecture of a segmentation neural network that includes a brain emulation sub-network that is derived from a synaptic connectivity graph representing synaptic connectivity between neurons in the brain of a biological organism.

FIG. 8 shows an example of a segmentation neural network that includes a brain emulation sub-network.

FIG. 9 shows an example architecture search system.

FIG. 10 shows an example constraint satisfaction system.

FIG. 11 shows an example evolutionary system.

FIG. 12 shows an example optimization system.

FIG. 13 is a block diagram of an example computer system.

Like reference numbers and designations in the various drawings indicate like elements.

### DETAILED DESCRIPTION

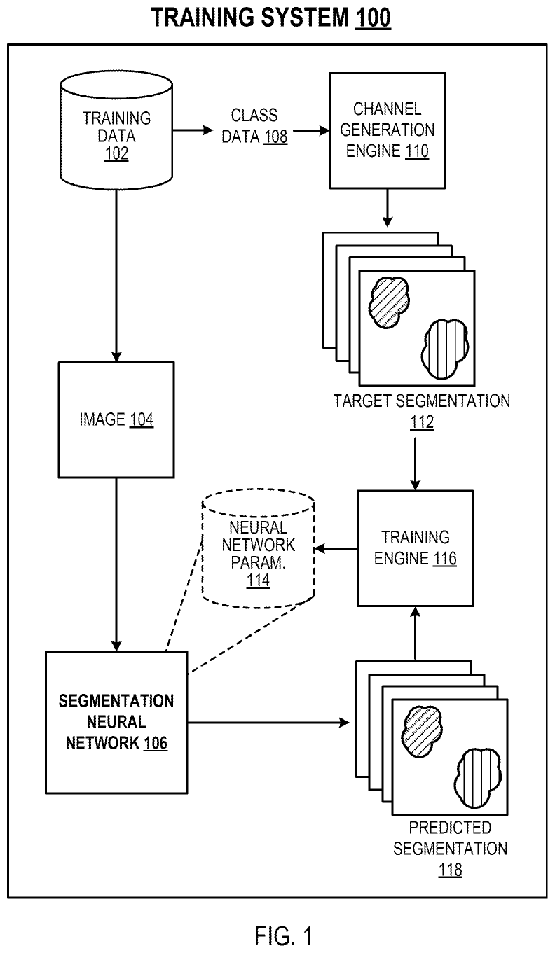

FIG. 1 shows an example training system 100. The training system 100 is an example of a system implemented as computer programs on one or more computers in one or more locations in which the systems, components, and techniques described below are implemented.

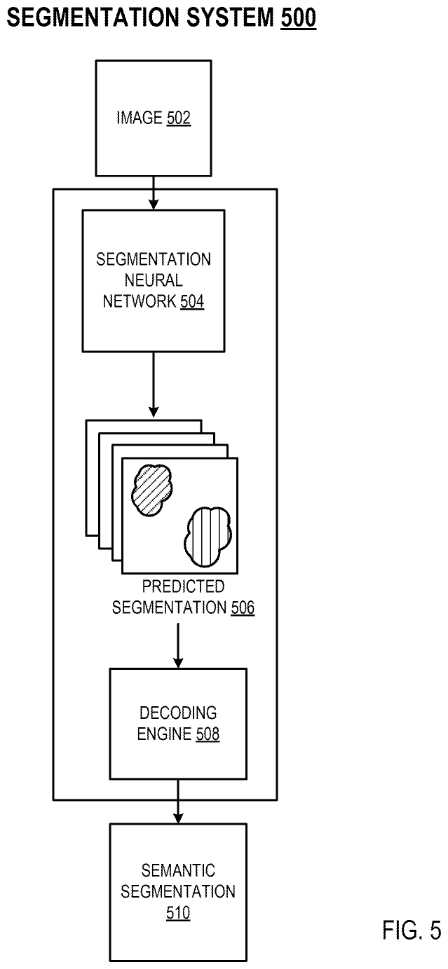

The training system 100 trains a segmentation neural network 106 that is used by a segmentation system, e.g., the segmentation system 500 described with reference to FIG. 5, to perform semantic image segmentation. More specifically, the segmentation system processes an image to generate a semantic segmentation of the image that defines a respective class, from a set of possible classes, for each pixel in the image.

The training system 100 trains the segmentation neural network 106 to process an image, in accordance with values of a set of segmentation neural network parameters 114, to generate a set of predicted channels, some or all of which are predicted contrastive channels. Each predicted contrastive channel corresponds to a respective pair of classes from the set of possible classes (including a “first” class and a “second” class). Each predicted contrastive channel includes a respective score for each pixel in the image that predicts whether the pixel is included in: (i) the first class corresponding to the contrastive channel, (ii) the second class corresponding to the contrastive channel, or (iii) any class other than the first class and the second class corresponding to the contrastive channel.

The training system 100 trains the segmentation neural network 106 on a set of training data 102 over a sequence of multiple training iterations. The set of training data 102 includes a set of training examples, where each training example includes: (i) a respective image, and (ii) class data defining a respective class, from the set of possible classes, corresponding to each pixel in the image. The set of training data 102 can include any appropriate number of training examples, e.g., 100 training examples, 1000 training examples, or 1,000,000 training examples.

At each training iteration, the training system 100 can sample a set of one or more training examples from the training data 102, where each sampled training example includes: (i) an image 104, and (ii) class data 108 that defines a respective class of each pixel in the image 104. The training system 100 can then train the segmentation neural network 106 on each of the sampled training examples.

To train the segmentation neural network 106 on a training example, the training system 100 can process the class data 108 from the training example, using a channel generation engine 110, to generate a target segmentation 112 for the image 104. The target segmentation 112 defines the output that should be generated by the segmentation neural network 106 by processing the image 104.

The target segmentation 112 includes a set of one or more target channels, including one or more target contrastive channels. Each target contrastive channel corresponds to a respective pair of classes from the set of possible classes, i.e., a respective first class and a respective second class from the set of possible classes. Each target contrastive channel includes a respective score for each pixel in the image that defines whether the pixel is included in: (i) the first class corresponding to the contrastive channel, (ii) the second class corresponding to the contrastive channel, or (iii) any class other than the first class or the second class corresponding to the contrastive channel.

To generate a target contrastive channel corresponding to a first class and a second class, the channel generation engine 110 can define: (i) each score in the target contrastive channel that corresponds to a respective pixel in the first class as having a first value, (ii) each score in the target contrastive channel that corresponds to a respective pixel in the second class as having a second value, and (iii) each score in the target contrastive channel that corresponds to a respective pixel in any class other than the first class or the second class as having a third value. The first, second, and third values are all generally different from one another.

For example, the channel generation engine 110 can define each score in the target contrastive channel that corresponds to a pixel in the first class as having value −1, each score in target contrastive channel that corresponds to a pixel in the second class as having value +1, and each score in the target contrastive channel that corresponds to a pixel in any class other than the first class or the second class as having value 0. In this example, the output layer of the segmentation neural network 106 can have a tanh activation function that allows the scores in channels generated by the segmentation neural network 106 to range over the interval (−1, +1).

As another example, the channel generation engine 110 can define each score in the target contrastive channel that corresponds to a pixel in the first class as having value 0, each score in the contrastive target channel that corresponds to a pixel in the second class as having value +1, and each score in the target contrastive channel that corresponds to a pixel in any class other than the first class or the second class as having value 0.5. In this example, the output layer of the segmentation neural network 106 can have a sigmoid activation function that allows the scores in channels generated by the segmentation neural network 106 to range over the interval (0,1).

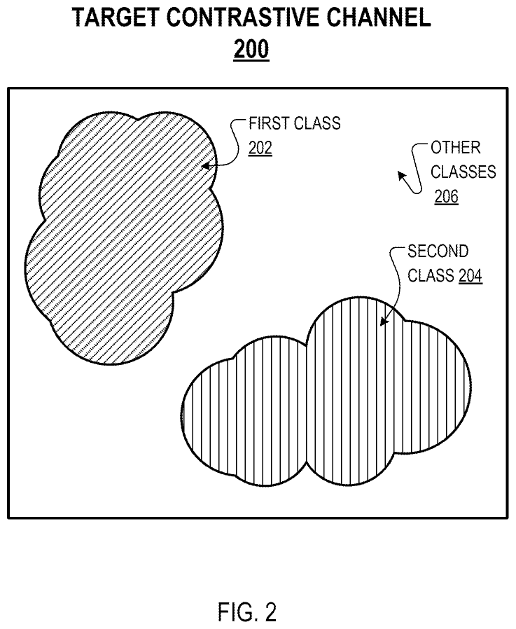

FIG. 2 provides an illustration of an example of a target contrastive channel 200. Each score in the target contrastive channel that corresponds to a pixel in a first class has a first value (e.g., −1) and is shown by the region 202. Each score in the target contrastive channel that corresponds to a pixel in a second class has a second value (e.g., +1) and is shown by the region 204. Each score in the target contrastive channel that corresponds to a pixel in any other than the first class or the second class has a third value (e.g., 0) is shown by the region 206.

Returning to the description of FIG. 1, in some implementations, the channel generation engine 110 can generate one or more target contrastive channels that each correspond to a respective set of more than two classes. For example, the channel generation engine 110 can generate a target contrastive channel that corresponds to N>2 classes that includes a respective score for each pixel in the image that defines whether the pixel is included in: (i) each of the N classes corresponding to the target contrastive channel, or (ii) any class other than the N classes corresponding to the target contrastive channel. For example, the channel generation engine 110 can define each score in the target contrastive channel that corresponds to a pixel in class n∈{1, . . . , N} as having value n, and each pixel in any class other than the N classes corresponding to the target contrastive channel as having value 0 (e.g., where the segmentation task can be understood as a partial regression task).

The training system 100 can determine which respective pairs of classes correspond to each target contrastive channel in any of a variety of possible ways. A few examples of techniques for determining which pairs of classes correspond to each target contrastive channel are described in more detail next.

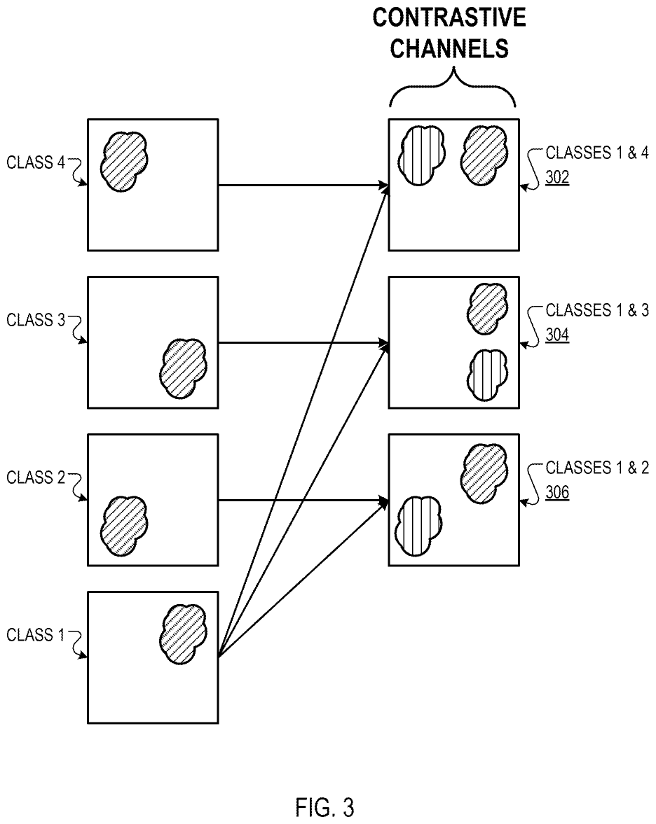

In some implementations, the training system 100 can determine that some or all of the contrastive channels correspond to respective pairs of classes that each include: (i) a same “base” class, and (ii) a respective different class (i.e., other than the base class). FIG. 3 illustrates an example where the training system 100 generates three target contrastive channels corresponding to a set of four possible classes. In particular, the training system 100 generates a contrastive channel 302 corresponding to classes 1 and 4, a contrastive channel 304 corresponding to classes 1 and 3, and a contrastive channel 306 corresponding to classes 1 and 2. That is, in the example illustrated in FIG. 3, class 1 represents the “base” class that is included in each contrastive channel.

The training system 100 can select the base class that is included in each target contrastive channel in any of a variety of ways. For example, the training system 100 can process the set of training data to determine, for each class in the set of classes, a number of pixels in images in the training data 102 that are included in the class. The training system 100 can then identify the base class as being the class that occurs most frequently in the training data, i.e., that class that includes the largest number of pixels in images in the training data 102. In a particular example, if the images in the training data 102 are satellite images and the set of possible classes includes a “vegetation” class, then the vegetation class may be identified as the base class that occurs most frequently in the training data and that is therefore added to each contrastive channel. In this example, one contrastive channel may correspond to “vegetation” and “buildings,” while another contrastive channel may corresponding to “vegetation” and “roads.” As another example, the training system 100 can randomly select the base class from the set of possible classes. As another example, the base class can be specified by a user of the training system 100.

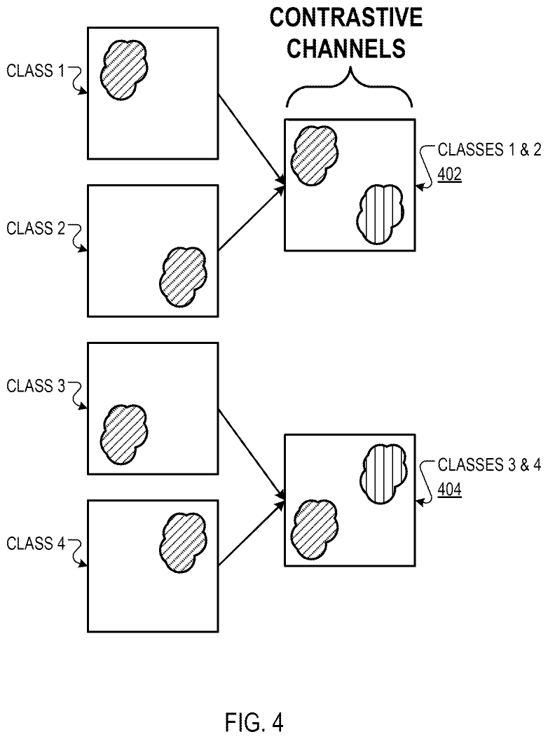

In some implementations, the training system 100 can determine that each contrastive channel corresponds to a respective pair of classes, including a first class and a second class, neither of which are included in any other contrastive channel. FIG. 4 illustrates an example where the training system 100 generates two contrastive channels corresponding to a set of four possible classes. In particular, the training system 100 generates a contrastive channel 402 corresponding to classes 1 and 2, and a contrastive channel 404 corresponding to classes 3 and 4. It can be appreciated that generating contrastive channels in this manner can reduce the number of target contrastive channels to be half the number of possible channels. Thus training the segmentation neural network generate the contrastive channels can reduce the number of output channels generated by the segmentation neural network by half, compared to, e.g., a segmentation neural network that generates a respective output channel corresponding to each possible class. The training system 100 can select the distinct pairs of classes to be included in each contrastive channel, e.g., by random selection, or the distinct pairs of classes to be included in each contrastive channel can be specified by a user of the training system 100. In some implementations, training the segmentation neural network to generate contrastive channels can reduce the number of output channels from N to log₂ N, where N is the number of possible classes.

Optionally, the channel generation engine 110 can generate one or more target “single class” channels to be included in the target segmentation, i.e., in addition to the contrastive channels. Each target single class channel corresponds to a single class from the set of possible classes. Each target single class channel includes a respective score for each pixel in the image 104 that defines whether the pixel is included in: (i) the class corresponding to the target single class channel, or (ii) any class other than the class corresponding to the target single class channel. For example, the channel generation engine 110 can define each score in a target single class channel that corresponds to a pixel in the class corresponding to the channel as having value +1, and each score in the target single class channel that corresponds to a pixel in any class other than the class corresponding to the channel as having value 0.

Generally, every class in the set of possible classes is included in at least one target channel in the target segmentation 112, and certain classes can be included in multiple target channels in the target segmentation 112.

In addition to generating the target segmentation 112 corresponding to the image 104, the training system 100 provides the image 104 as an input to the segmentation neural network 106. The segmentation neural network 106 processes the image 104, in accordance with the set of segmentation neural network parameters 114, to generate a predicted segmentation 118 that includes a respective “predicted” channel corresponding to each target channel in the target segmentation 112. Each predicted channel in the predicted segmentation 118 represents a prediction for the corresponding target channel in the target segmentation 112.

The training system 100 provides the predicted segmentation 118 and the target segmentation 112 to a training engine 116. The training engine 116 evaluates an objective function that measures an error between the predicted segmentation 118 and the target segmentation 112, and determines gradients of the objective function with respect to some or all of the segmentation neural network parameters 114. The objective function can be, e.g., a cross-entropy objective function or an intersection over union (IOU) objective function. The training engine 116 can determine the gradients of the objective function with respect to the segmentation neural network parameters 114, e.g., by backpropagation. The training engine 116 uses the gradients the update the values of the segmentation neural network parameters 114 uses any appropriate gradient descent optimization procedure, e.g., RMSprop or Adam. Thus, the training engine 116 trains the segmentation neural network 106 to generate a predicted segmentation 118 that matches the target segmentation 112.

Training the segmentation neural network 106 to generate contrastive channels (rather than only single class channels) can improve the prediction accuracy of the segmentation neural network 106. In particular, generating a contrastive channel requires the segmentation neural network 106 to generate informative internal representations of an input image (e.g., in the hidden layers of the segmentation neural network) to simultaneously distinguish between multiple classes in a single channel. Put another way, learning to generate a contrastive channel trains the segmentation neural network to identify the features of a first class by directly contrasting the features of the first class with those of a second class, and vice versa. Learning to generate a contrastive channel thereby enables the segmentation neural network to discover the most relevant features for distinguishing each class from each other class, thereby improving prediction accuracy.

The segmentation neural network architecture can have any appropriate neural network architecture that enables it to perform its described function, i.e., processing an image to generate a predicted segmentation. For example, the segmentation neural network 106 can include any appropriate types of neural network layers (e.g., fully-connected layers, convolutional layers, attention layers, etc.) in any appropriate numbers (e.g., 5 layers, 10 layers, or 100 layers) and connected in any appropriate configuration (e.g., as a linear sequence of layers).

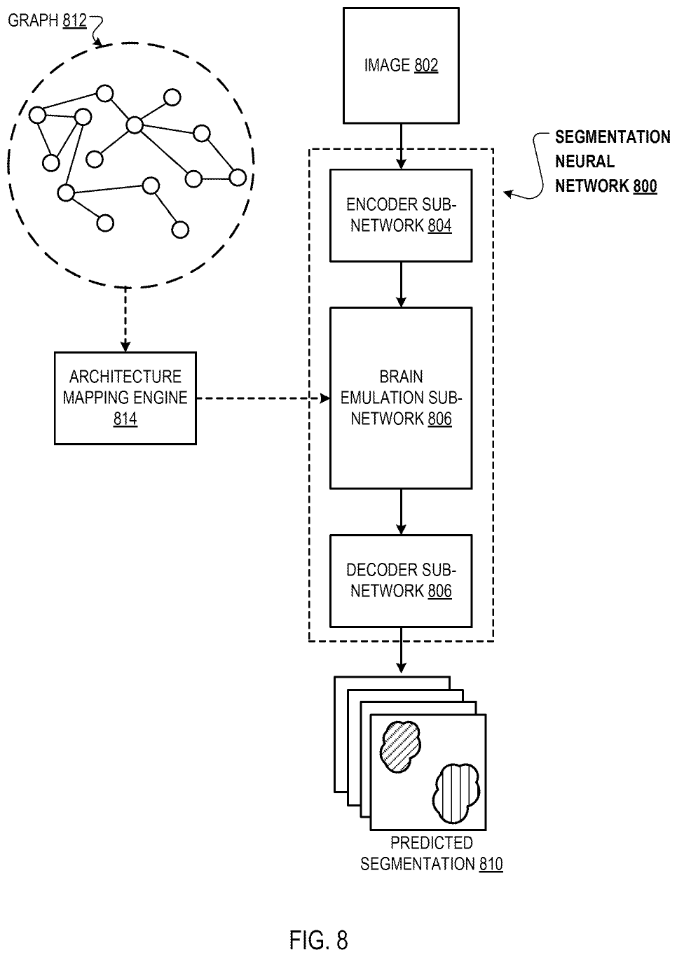

In some implementations, the segmentation neural network includes a “brain emulation” sub-network, i.e., a sub-network having a neural network architecture that is determined from a synaptic connectivity graph representing synaptic connectivity in a brain of a biological organism. An example of a neural network that includes a brain emulation sub-network is described in more detail with reference to FIG. 8.

For convenience, throughout this specification, a neural network having an architecture derived from a synaptic connectivity graph may be referred to as a “brain emulation” neural network. Identifying an artificial neural network as a “brain emulation” neural network is intended only to conveniently distinguish such neural networks from other neural networks (e.g., with hand-engineered architectures), and should not be interpreted as limiting the nature of the operations that may be performed by the neural network or otherwise implicitly characterizing the neural network.

FIG. 5 shows an example segmentation system 500. The segmentation system 500 is an example of a system implemented as computer programs on one or more computers in one or more locations in which the systems, components, and techniques described below are implemented.

The segmentation system 500 is configured to process an image 502 to generate a semantic segmentation 510 of the image 502 that defines a respective class, from a set of possible classes, for each pixel in the image 502.

To generate the semantic segmentation 510, the segmentation system 500 processes the image using a segmentation neural network 504, e.g., that is trained by the training system 100 described with reference to FIG. 1, to generate a predicted segmentation 506. The predicted segmentation 506 includes one or more predicted contrastive channels that each correspond to a respective pair of classes (including a respective first class and a respective second class) from the set of possible classes. Each predicted contrastive channel includes a respective score for each pixel in the image 502 that predicts whether the pixel is included in: (i) the first class corresponding to the predicted contrastive channel, (ii) the second class corresponding to the predicted contrastive channel, or (iii) any class other than the first class or the second class corresponding to the predicted contrastive channel.

The segmentation system 500 processes the predicted segmentation 506 using a decoding engine 508 to generate the semantic segmentation 510 of the image 502.

To determine the class of a pixel in the image 502, the decoding engine 508 can identify the predicted contrastive channel that defines the most “confident” prediction for the pixel. That is, the decoding engine 508 can identify the predicted contrastive channel for which the score for the pixel is closest to an endpoint of a range of possible scores. The range of possible scores can be, e.g., [−1,1], if the activation function of the output layer of the segmentation neural network is a tanh function. The decoding engine 508 can then determine the class of the pixel to be the class predicted for the pixel by the most confident predicted contrastive channel. As an illustrative example, the most confident predicted contrastive channel may define a score of 0.92 for the pixel, where the range of possible scores is [−1,1], the score value −1 is associated with the class “water,” and the score value 1 is associated with the class “vegetation.” In this example, the decoding engine 508 can determine the predicted class of the pixel to be “vegetation.” In some implementations, pixels with scores that deviate by more than a predefined threshold amount from each endpoint of the range of possible scores in the most confident predicted contrastive channel are not associated with any class in the semantic segmentation.

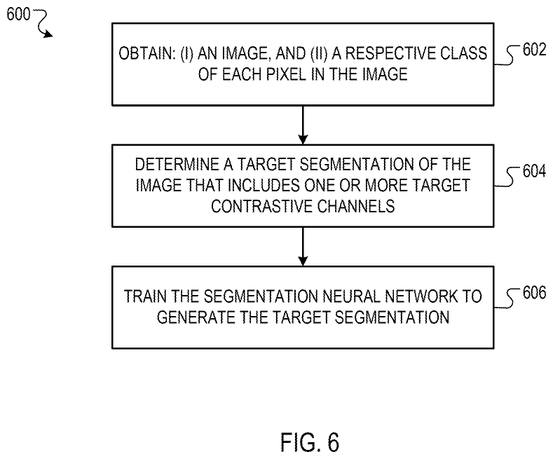

FIG. 6 is a flow diagram of an example process 600 for training a segmentation neural network. For convenience, the process 600 will be described as being performed by a system of one or more computers located in one or more locations. For example, a training system, e.g., the training system 100 of FIG. 1, appropriately programmed in accordance with this specification, can perform the process 600.

The system obtains data defining: (i) an image, and (ii) a respective class of each pixel in the image from a set of possible classes (602).

The system determines a target segmentation of the image that includes one or more target contrastive channels (604). Each target contrastive channel corresponds to a respective pair of classes including a respective first class and a respective second class from the set of possible classes. Each target contrastive channel includes a respective score for each pixel in the image that defines whether the pixel is included in: (i) the first class corresponding to the target contrastive channel, (ii) the second class corresponding to the target contrastive channel, or (iii) any class other than the first class or the second class corresponding to the target contrastive channel.

For each target contrastive channel, the respective score for each pixel can have a first value if the pixel is included in the first class corresponding to the target contrastive channel, a second value if the pixel is included in the second class corresponding to the target contrastive channel, and a third value if the pixel is included in any class other than the first class or the second class corresponding to the target contrastive channel. For example, if an activation function in an output layer of the segmentation neural network is a tanh activation function, and then the first value can be −1, the second value can be +1, and the third value can be 0.

The system trains the segmentation neural network to process the image to generate a predicted segmentation that matches the target segmentation (606). For example, the system can process the image using the segmentation neural network, in accordance with values of the segmentation neural network parameters, to generate a predicted segmentation output that includes a respective predicted channel corresponding to each target channel in the target segmentation output. The system can then update the values of the segmentation neural network parameters using gradients of an objective function that measures an error between: (i) the predicted segmentation output, and (ii) the target segmentation output.

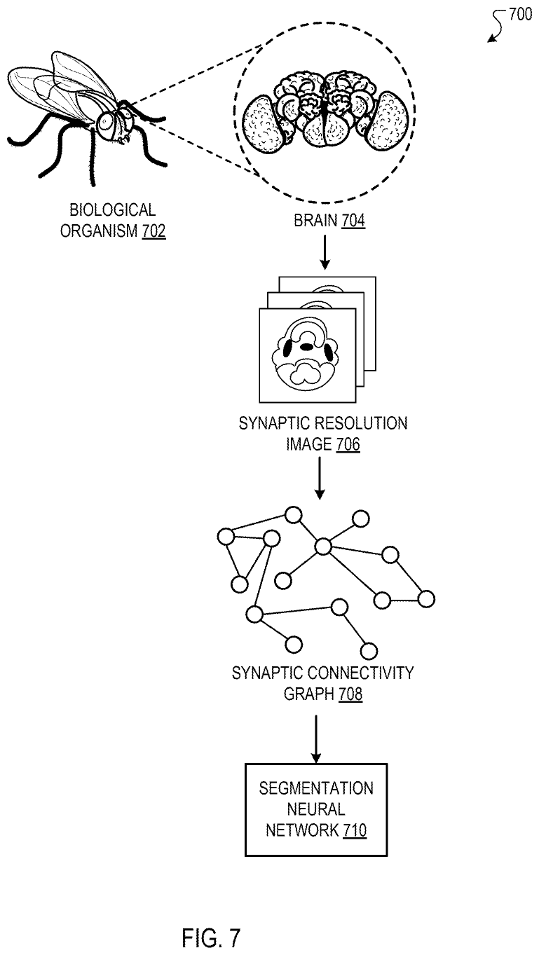

FIG. 7 shows an example data flow 700 for determining an architecture of a segmentation neural network 710 that includes a “brain emulation” sub-network that is derived from a synaptic connectivity graph 708 representing synaptic connectivity between neurons in the brain 704 of a biological organism 702.

As used throughout this document, a brain may refer to any amount of nervous tissue from a nervous system of a biological organism, and nervous tissue may refer to any tissue that includes neurons (i.e., nerve cells). The biological organism 702 may be, e.g., a worm, a fly, a mouse, a cat, or a human.

An imaging system may be used to generate a synaptic resolution image 706 of the brain 704. An image of the brain 704 may be referred to as having synaptic resolution if it has a spatial resolution that is sufficiently high to enable the identification of at least some synapses in the brain 704. Put another way, an image of the brain 704 may be referred to as having synaptic resolution if it depicts the brain 704 at a magnification level that is sufficiently high to enable the identification of at least some synapses in the brain 704. The image 706 may be a volumetric image, i.e., that characterizes a three-dimensional representation of the brain 704. The image 706 may be represented in any appropriate format, e.g., as a three-dimensional array of numerical values.

The imaging system may be any appropriate system capable of generating synaptic resolution images, e.g., an electron microscopy system. The imaging system may process “thin sections” from the brain 704 (i.e., thin slices of the brain attached to slides) to generate output images that each have a field of view corresponding to a proper subset of a thin section. The imaging system may generate a complete image of each thin section by stitching together the images corresponding to different fields of view of the thin section using any appropriate image stitching technique. The imaging system may generate the volumetric image 706 of the brain by registering and stacking the images of each thin section. Registering two images refers to applying transformation operations (e.g., translation or rotation operations) to one or both of the images to align them. Example techniques for generating a synaptic resolution image of a brain are described with reference to: Z. Zheng, et al., “A complete electron microscopy volume of the brain of adult Drosophila melanogaster,” Cell 174, 730-743 (2018).

A graphing system may be used to process the synaptic resolution image 706 to generate the synaptic connectivity graph 708. The synaptic connectivity graph 708 specifies a set of nodes and a set of edges, such that each edge connects two nodes. To generate the graph 708, the graphing system identifies each neuron in the image 706 as a respective node in the graph, and identifies each synaptic connection between a pair of neurons in the image 706 as an edge between the corresponding pair of nodes in the graph.

The graphing system may identify the neurons and the synapses depicted in the image 706 using any of a variety of techniques. For example, the graphing system may process the image 706 to identify the positions of the neurons depicted in the image 706, and determine whether a synapse connects two neurons based on the proximity of the neurons (as will be described in more detail below). In this example, the graphing system may process an input including: (i) the image, (ii) features derived from the image, or (iii) both, using a machine learning model that is trained using supervised learning techniques to identify neurons in images. The machine learning model may be, e.g., a convolutional neural network model or a random forest model. The output of the machine learning model may include a neuron probability map that specifies a respective probability that each voxel in the image is included in a neuron. The graphing system may identify contiguous clusters of voxels in the neuron probability map as being neurons.

Optionally, prior to identifying the neurons from the neuron probability map, the graphing system may apply one or more filtering operations to the neuron probability map, e.g., with a Gaussian filtering kernel. Filtering the neuron probability map may reduce the amount of “noise” in the neuron probability map, e.g., where only a single voxel in a region is associated with a high likelihood of being a neuron.

The machine learning model used by the graphing system to generate the neuron probability map may be trained using supervised learning training techniques on a set of training data. The training data may include a set of training examples, where each training example specifies: (i) a training input that can be processed by the machine learning model, and (ii) a target output that should be generated by the machine learning model by processing the training input. For example, the training input may be a synaptic resolution image of a brain, and the target output may be a “label map” that specifies a label for each voxel of the image indicating whether the voxel is included in a neuron. The target outputs of the training examples may be generated by manual annotation, e.g., where a person manually specifies which voxels of a training input are included in neurons.

Example techniques for identifying the positions of neurons depicted in the image 706 using neural networks (in particular, flood-filling neural networks) are described with reference to: P. H. Li et al.: “Automated Reconstruction of a Serial-Section EM Drosophila Brain with Flood-Filling Networks and Local Realignment,” bioRxiv doi:10.1101/605634 (2019).

The graphing system may identify the synapses connecting the neurons in the image 706 based on the proximity of the neurons. For example, the graphing system may determine that a first neuron is connected by a synapse to a second neuron based on the area of overlap between: (i) a tolerance region in the image around the first neuron, and (ii) a tolerance region in the image around the second neuron. That is, the graphing system may determine whether the first neuron and the second neuron are connected based on the number of spatial locations (e.g., voxels) that are included in both: (i) the tolerance region around the first neuron, and (ii) the tolerance region around the second neuron. For example, the graphing system may determine that two neurons are connected if the overlap between the tolerance regions around the respective neurons includes at least a predefined number of spatial locations (e.g., one spatial location). A “tolerance region” around a neuron refers to a contiguous region of the image that includes the neuron. For example, the tolerance region around a neuron may be specified as the set of spatial locations in the image that are either: (i) in the interior of the neuron, or (ii) within a predefined distance of the interior of the neuron.

The graphing system may further identify a weight value associated with each edge in the graph 708. For example, the graphing system may identify a weight for an edge connecting two nodes in the graph 708 based on the area of overlap between the tolerance regions around the respective neurons corresponding to the nodes in the image 706. The area of overlap may be measured, e.g., as the number of voxels in the image 706 that are contained in the overlap of the respective tolerance regions around the neurons. The weight for an edge connecting two nodes in the graph 708 may be understood as characterizing the (approximate) strength of the connection between the corresponding neurons in the brain (e.g., the amount of information flow through the synapse connecting the two neurons).

In addition to identifying synapses in the image 706, the graphing system may further determine the direction of each synapse using any appropriate technique. The “direction” of a synapse between two neurons refers to the direction of information flow between the two neurons, e.g., if a first neuron uses a synapse to transmit signals to a second neuron, then the direction of the synapse would point from the first neuron to the second neuron. Example techniques for determining the directions of synapses connecting pairs of neurons are described with reference to: C. Seguin, A. Razi, and A. Zalesky: “Inferring neural signalling directionality from undirected structure connectomes,” Nature Communications 10, 4289 (2019), doi:10.1038/s41467-019-12201-w.

In implementations where the graphing system determines the directions of the synapses in the image 706, the graphing system may associate each edge in the graph 708 with the direction of the corresponding synapse. That is, the graph 708 may be a directed graph. In other implementations, the graph 708 may be an undirected graph, i.e., where the edges in the graph are not associated with a direction.

The graph 708 may be represented in any of a variety of ways. For example, the graph 708 may be represented as a two-dimensional array of numerical values, referred to as an “adjacency matrix”, with a number of rows and columns equal to the number of nodes in the graph. The component of the array at position (i,j) may have value 1 if the graph includes an edge pointing from node i to node j, and value 0 otherwise. In implementations where the graphing system determines a weight value for each edge in the graph 708, the weight values may be similarly represented as a two-dimensional array of numerical values. More specifically, if the graph includes an edge connecting node i to node j, the component of the array at position (i,j) may have a value given by the corresponding edge weight, and otherwise the component of the array at position (i,j) may have value 0.

After being generated, the synaptic connectivity graph can be used to determine the architecture of a brain emulation sub-network of the segmentation neural network 710. An example of a segmentation neural network 710 that includes a brain emulation sub-network having an architecture that is determined from a synaptic connectivity graph 708 is described in more detail with reference to FIG. 8.

FIG. 8 shows an example of a segmentation neural network 800 that includes a brain emulation sub-network 806 having an architecture that is determined from a synaptic connectivity graph representing synaptic connectivity between biological neurons in a brain of a biological organism.

The segmentation neural network 800 is configured to process an image 802 to generate a predicted segmentation 810. The predicted segmentation 810 includes one or more predicted contrastive channels that each correspond to a respective pair of classes (including a respective first class and a respective second class) from a set of possible classes. Each predicted contrastive channel includes a respective score for each pixel in the image 802 that predicts whether the pixel is included in: (i) the first class corresponding to the predicted contrastive channel, (ii) the second class corresponding to the predicted contrastive channel, or (iii) any class other than the first class or the second class corresponding to the predicted contrastive channel.

The segmentation neural network 800 can be trained, e.g., using the training system 100 described with reference to FIG. 1, and can be used as part of a segmentation system, e.g., the segmentation system 500 described with reference to FIG. 5.

The segmentation neural network 800 can include: (i) an encoder sub-network 804, (ii) a brain emulation sub-network 806, and (iii) a decoder sub-network 806.

The encoder sub-network 804 is configured to process the image 802 to generate an embedding of the image 802, i.e., a representation of the image as an ordered collection of numerical values, e.g., a vector or matrix of numerical values. In some cases, the embedding of the image 802 can be represented, e.g., as an ordered collection of channels, where each channel is a 2D array of latent values that implicitly characterize features of the image. The encoder sub-network may have any appropriate neural network architecture that enables it to perform its described function. In particular, the encoder sub-network can include any appropriate types of neural network layers (e.g., fully-connected layers, convolutional layers, attention layers, etc.) in any appropriate numbers (e.g., 1 layer, 5, layers, 10 layers, etc.) and connected in any appropriate configuration, e.g., as a linear sequence of layers.

The brain emulation sub-network 806 is configured to process the embedding of the image (i.e., that is generated by the encoder sub-network) to generate an alternative representation of the image, e.g., as an ordered collection of numerical values, e.g., a vector or matrix of numerical values. In some cases, the alternative representation of the image can be represented, e.g., as an ordered collection of channels, where each channel is a 2D array of latent values that implicitly characterize features of the image.

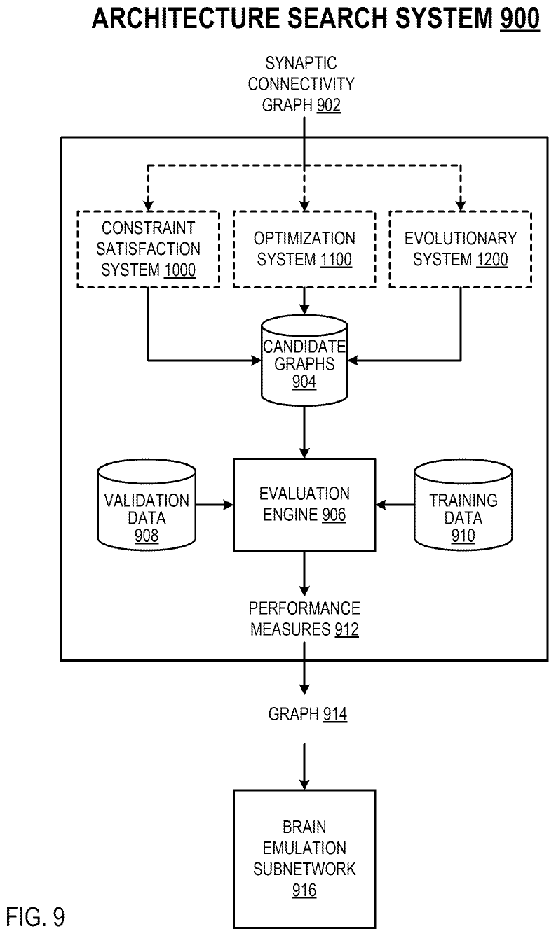

The architecture of the brain emulation sub-network 806 is specified by a graph 812, e.g., a synaptic connectivity graph representing synaptic connectivity between biological neurons in a brain of a biological organism, or a graph that is otherwise derived from a synaptic connectivity graph. An example of an architecture search system 900 that processes a synaptic connectivity graph to generate a graph 812 that defines an architecture of a brain emulation sub-network is described in more detail with reference to FIG. 9. In some cases, the graph 812 is a sub-graph of a larger synaptic connectivity graph derived from a synaptic resolution image of a brain, e.g., a sub-graph that includes only neurons that are predicted to be of a particular type, e.g., visual neurons, olfactory neurons, or memory neurons. (As used throughout this specification, a “sub-graph” refers to a graph that includes a proper subset of the nodes and the edges of a larger graph).

An architecture mapping engine 814 can specify the architecture of the brain emulation sub-network 806 from the graph 812 in a variety of possible ways, as will be described in more detail below.

The decoder sub-network 806 is configured to process the alternative representation of the image 802 (i.e., that is generated by the brain emulation sub-network 806) to generate the predicted segmentation 810 of the image 802. The decoder sub-network 806 may have any appropriate neural network architecture that enables it to perform its described function. In particular, the decoder sub-network can include any appropriate types of neural network layers (e.g., fully-connected layers, convolutional layers, attention layers, etc.) in any appropriate numbers (e.g., 1 layer, 5, layers, 10 layers, etc.) and connected in any appropriate configuration, e.g., as a linear sequence of layers.

The architecture mapping engine 814 can map the graph 812 onto a corresponding architecture of the brain emulation sub-network 806 in any of a variety of ways. For example, the architecture mapping engine 814 can map each node in the graph 812 onto a corresponding: (i) artificial neuron, (ii) artificial neural network layer, or (iii) group of artificial neural network layers in the brain emulation sub-network architecture, as will be described in more detail next.

In one example, the brain emulation sub-network architecture may include: (i) a respective artificial neuron corresponding to each node in the graph 812, and (ii) a respective connection corresponding to each edge in the graph 812. In this example, the graph 812 may be a directed graph, and an edge that points from a first node to a second node in the graph 812 may specify a connection pointing from a corresponding first artificial neuron to a corresponding second artificial neuron in the brain emulation sub-network architecture. The connection pointing from the first artificial neuron to the second artificial neuron may indicate that the output of the first artificial neuron should be provided as an input to the second artificial neuron. Each connection in the brain emulation sub-network architecture may be associated with a weight (parameter) value, e.g., that is specified by the weight value associated with the corresponding edge in the graph 812. An artificial neuron may refer to a component of the brain emulation sub-network architecture that is configured to receive one or more inputs (e.g., from one or more other artificial neurons), and to process the inputs to generate an output. The inputs to an artificial neuron and the output generated by the artificial neuron may be represented as scalar numerical values. In one example, a given artificial neuron may generate an output b as:

$$b = σ ( {\sum }_{i = 1}^{n} {w}_{i} \cdot {a}_{i} ) \qquad ( 1 )$$

where σ(⋅) is a non-linear “activation” function (e.g., a sigmoid function or an arctangent function), {aᵢ}ᵢ₌₁ⁿ are the inputs provided to the given artificial neuron, and {wᵢ}ᵢ₌₁ⁿ are the weight values (i.e., parameter values) associated with the connections between the given artificial neuron and each of the other artificial neurons that provide an input to the given artificial neuron.

In another example, the graph 812 may be an undirected graph, and the architecture mapping engine can map an edge that connects a first node to a second node in the graph 812 onto two connections between a corresponding first artificial neuron and a corresponding second artificial neuron in the brain emulation sub-network architecture. In particular, the architecture mapping engine 814 may map the edge to: (i) a first connection pointing from the first artificial neuron to the second artificial neuron, and (ii) a second connection pointing from the second artificial neuron to the first artificial neuron.

In another example, the graph 812 may be an undirected graph, and the architecture mapping engine 814 may map an edge that connects a first node to a second node in the graph 812 to one connection between a corresponding first artificial neuron and a corresponding second artificial neuron in the brain emulation sub-network architecture. The architecture mapping engine 814 may determine the direction of the connection between the first artificial neuron and the second artificial neuron, e.g., by randomly sampling the direction in accordance with a probability distribution over the set of two possible directions.

In another example, the brain emulation sub-network architecture may include: (i) a respective artificial neural network layer corresponding to each node in the graph 812, and (ii) a respective connection corresponding to each edge in the graph 812. In this example, a connection pointing from a first layer to a second layer may indicate that the output of the first layer should be provided as an input to the second layer. An artificial neural network layer may refer to a collection of artificial neurons, and the inputs to a layer and the output generated by the layer may be represented as ordered collections of numerical values (e.g., tensors of numerical values). In one example, the brain emulation sub-network architecture may include a respective convolutional neural network layer corresponding to each node in the graph 812, and each given convolutional layer may generate an output d as:

$$d = σ ( {h}_{θ} ( {\sum }_{i = 1}^{n} {w}_{i} \cdot {c}_{i} ) ) \qquad ( 2 )$$

where each cᵢ (i=1, . . . , n) is a tensor (e.g., a two- or three-dimensional array) of numerical values provided as an input to the layer, each wᵢ (i=1, n) is a weight value associated with the connection between the given layer and each of the other layers that provide an input to the given layer (where the weight value for each edge may be specified by the weight value associated with the corresponding edge in the graph), h_{θ}(⋅) represents the operation of applying one or more convolutional kernels to an input to generate a corresponding output, and σ(⋅) is a non-linear activation function that is applied element-wise to each component of its input. In this example, each convolutional kernel may be represented as an array of numerical values, e.g., where each component of the array is randomly sampled from a predetermined probability distribution, e.g., a standard Normal probability distribution.

In another example, the architecture mapping engine may determine that the brain emulation sub-network architecture includes: (i) a respective group of artificial neural network layers corresponding to each node in the graph 812, and (ii) a respective connection corresponding to each edge in the graph 812. The layers in a group of artificial neural network layers corresponding to a node in the graph 812 may be connected, e.g., as a linear sequence of layers, or in any other appropriate manner.

When the graph is a synaptic connectivity graph (or a sub-graph of a synaptic connectivity graph), then the architecture of the brain emulation neural network can directly represent synaptic connectivity in a region of the brain of the biological organism. More specifically, the architecture mapping engine 814 can map the nodes of the synaptic connectivity graph (which each represent a biological neuron in the brain) onto corresponding artificial neurons in the brain emulation sub-network. The architecture mapping engine 814 can also map the edges of the synaptic connectivity graph (which each represent a synaptic connection between a pair of biological neurons in the brain) onto connections between corresponding pairs of artificial neurons in the brain emulation sub-network. The architecture mapping engine 814 can map the respective weight associated with each edge in the synaptic connectivity graph to a corresponding weight (i.e., parameter value) of a corresponding connection in the brain emulation sub-network. The weight corresponding to an edge (representing a synaptic connection in the brain) between a pair of nodes in the synaptic connectivity graph (representing a pair of biological neurons in the brain) can represent a proximity of the pair of biological neurons in the brain, as described above.

The output of the encoder sub-network can be provided as an input to the brain emulation sub-network in a variety of possible ways. For example, the encoder sub-network can include a respective connection from each artificial neuron in an output layer of the encoder sub-network to each of one or more artificial neurons of the brain emulation sub-network that are designated as input neurons. In some cases, the output layer of the encoder sub-network is fully-connected to the neurons of the brain emulation sub-network, i.e., such that the encoder sub-network includes a respective connection from each artificial neuron in the output layer of the encoder sub-network to each artificial neuron in the brain emulation sub-network.

The output of the brain emulation sub-network 806 can be provided as an input to the decoder sub-network 806 in a variety of possible ways. For example, the decoder sub-network 806 can include a respective connection from each artificial neuron in the brain emulation sub-network that is designated as an output neuron to each of one or more artificial neurons in the input layer of the decoder sub-network 806. In some cases, the artificial neurons of the brain emulation sub-network are fully-connected to the input layer of the decoder sub-network, i.e., such that the decoder sub-network includes a respective connection from each artificial neuron in the brain emulation sub-network to each artificial neuron in the input layer of the decoder sub-network.

The segmentation neural network 800 shown in FIG. 8 is provided for illustrative purposes only, and other segmentation neural network architectures are possible. For example, the segmentation neural network can include multiple brain emulation sub-networks, e.g., that are each specified by respective (possibly different) sub-graphs of a synaptic connectivity graph. The multiple brain emulation sub-networks can be arranged in a sequence, and be interleaved with fully-connected layers, convolutional layers, attention layers, or any other appropriate neural network layers. Put another way, the encoder sub-network 804 can be include one or more additional brain emulation sub-networks, and the decoder sub-network 806 can include one or more additional brain emulation sub-networks.

The segmentation neural network 800 can be trained on a set of training data by a training system, e.g., the training system 100 described with reference to FIG. 1. In some implementations, during training of the segmentation neural network 800, the training system can train some or all of the parameters of the encoder sub-network and some or all of the parameters of the decoder sub-network 806, while refraining from training the parameters of the brain emulation sub-network 806. Instead of being trained, the parameter values of the brain emulation sub-network may be determined from the synaptic resolution image of the brain, e.g., based on proximity between biological neurons in the brain of the biological organism, which can represent the strength of synaptic connections in the biological brain. Thus the parameter values of the brain emulation sub-network can encode aspects of the biological intelligence of the brain and can be used to harness capabilities of the brain, e.g., to generate representations that are effective for solving tasks, without requiring training. In some implementations, the training system 100 can train some or all of the parameters of the brain emulation sub-network.

FIG. 9 shows an example architecture search system 900. The architecture search system 900 is an example of a system implemented as computer programs on one or more computers in one or more locations in which the systems, components, and techniques described below are implemented.

The architecture search system 900 is configured to search a space of possible graphs to identify a graph 914 that specifies an artificial neural network architecture that can be used to effectively perform a semantic segmentation task (e.g., processing an image to generate a predicted segmentation of the image). The architecture search system 900 may “seed” (i.e., initialize) the search through the space of possible graphs using a synaptic connectivity graph 902 representing synaptic connectivity in the brain of a biological organism. In particular, the architecture search system 900 may use the synaptic connectivity graph 902 to derive a set of “candidate” graphs 904, each of which can be mapped to a corresponding neural network architecture, e.g., using the architecture mapping engine described with reference to FIG. 8. The architecture search system 900 may use an evaluation engine 906 to determine a performance measure 912 for each candidate graph 904 that characterizes the performance of the neural network architecture specified by the candidate graph on the semantic segmentation task. The architecture search system 900 may identify the best-performing graph 914 based on the performance measures 912, and then use the best-performing graph 914 to specify the architecture of the brain emulation sub-network 916.

Generally, the performance of a neural network on a machine learning task depends on the architecture of the neural network. The brain of a biological organism may be adapted by evolutionary pressures to be effective at solving certain tasks, and therefore a neural network having an architecture specified by a synaptic connectivity graph corresponding to the brain may inherit the capacity to effectively solve tasks. By seeding the neural architecture search process using the synaptic connectivity graph, the architecture search system 900 may facilitate the discovery of large numbers of biologically-inspired neural network architectures, some of which may be particularly effective at performing certain machine learning tasks.

The synaptic connectivity graph 902 provided to the architecture search system 900 may be derived directly from a synaptic resolution image of the brain of a biological organism, e.g., as described with reference to FIG. 7. In some cases, the synaptic connectivity graph 902 may be a sub-graph of a larger graph derived from a synaptic resolution image of a brain, e.g., a sub-graph that includes neurons of a particular type, e.g., visual neurons, olfactory neurons, or memory neurons.

The architecture search system 900 may generate the set of candidate graphs 904 from the synaptic connectivity graph 902 using any of a variety of techniques. A few examples follow.

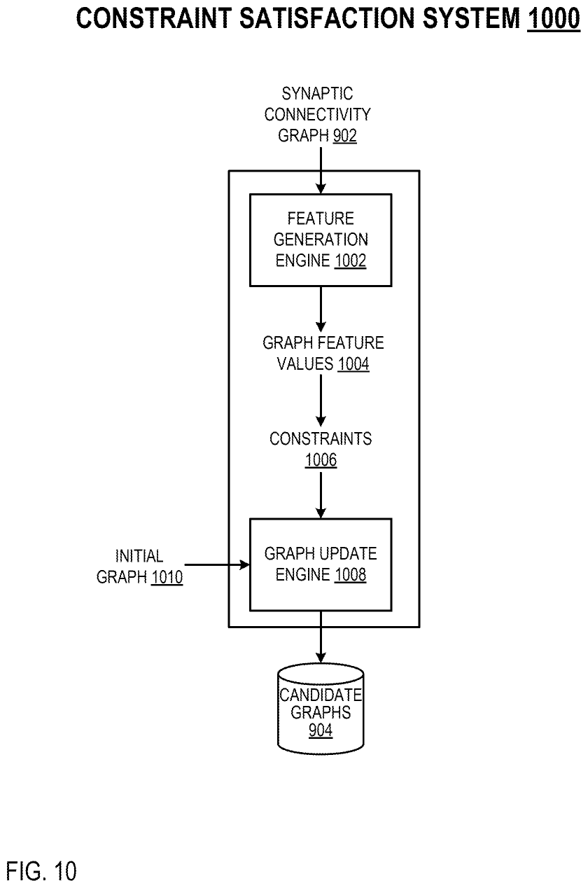

In one example, the architecture search system 900 may use a constraint satisfaction system 1000 to generate the set of candidate graphs 904 from the synaptic connectivity graph 902. To generate the candidate graphs 904, the constraint satisfaction system 1000 may process the synaptic connectivity graph 902 to determine values of a set of graph features characterizing the synaptic connectivity graph 902. Graph features characterizing a graph may include, e.g., the number of nodes in the graph, the fraction of pairs of nodes in the graph that are connected by edges, and the average path length between pairs of nodes in the graph. The constraint satisfaction system 1000 may use the values of the graph features characterizing the synaptic connectivity graph 902 to generate a set of “constraints” on the candidate graphs 904. Each constraint corresponds to a graph feature and specifies a target value or range of target values for the corresponding graph feature of each candidate graph 904. The constraint satisfaction system 1000 may then generate candidate graphs using a procedure defined by the constraints, e.g., such that each candidate graph satisfies at least one of the constraints. An example constraint satisfaction system 1000 is described in more detail with reference to FIG. 10.

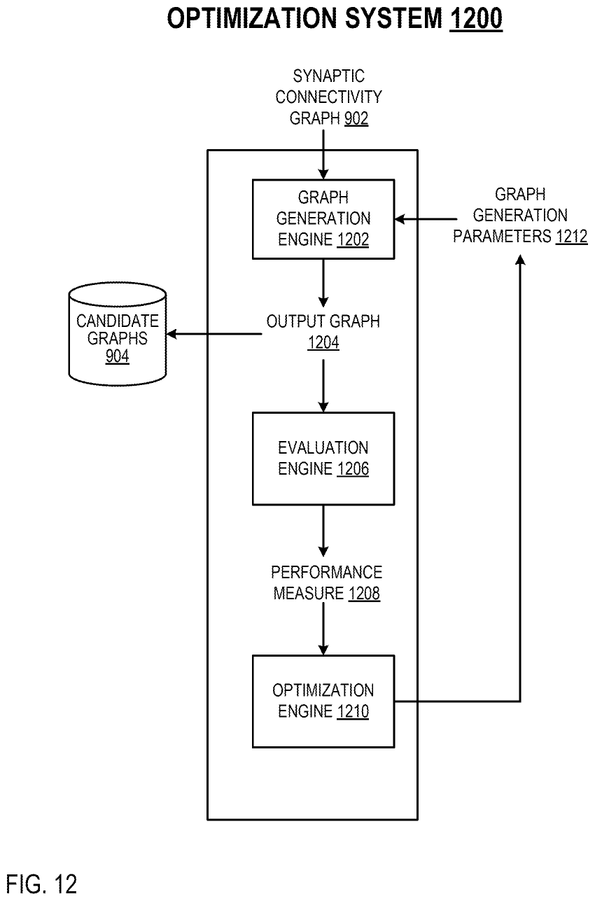

In another example, the architecture search system 900 may use an evolutionary system 1200 to generate the set of candidate graphs 904 from the synaptic connectivity graph 902. The evolutionary system 1200 may generate the candidate graphs 904 by “evolving” a population (i.e., a set) of graphs derived from the synaptic connectivity graph 902 over multiple iterations (referred to herein as “evolutionary” iterations). The evolutionary system 1200 may initialize the population of graphs, e.g., by “mutating” multiple copies of the synaptic connectivity graph 902. Mutating a graph refers to making a random change to the graph, e.g., by randomly adding or removing edges or nodes from the graph. After initializing the population of graphs, the evolutionary system 1200 may change the population of graphs at each evolutionary iteration, e.g., by removing graphs, adding new graphs, or modifying the existing graphs, based on the performance of the neural network architectures specified by the population of graphs. The evolutionary system 1200 may identify the population of graphs after the final evolutionary iteration as the set of candidate graphs 904. An example evolutionary system 1200 is described in more detail with reference to FIG. 12.

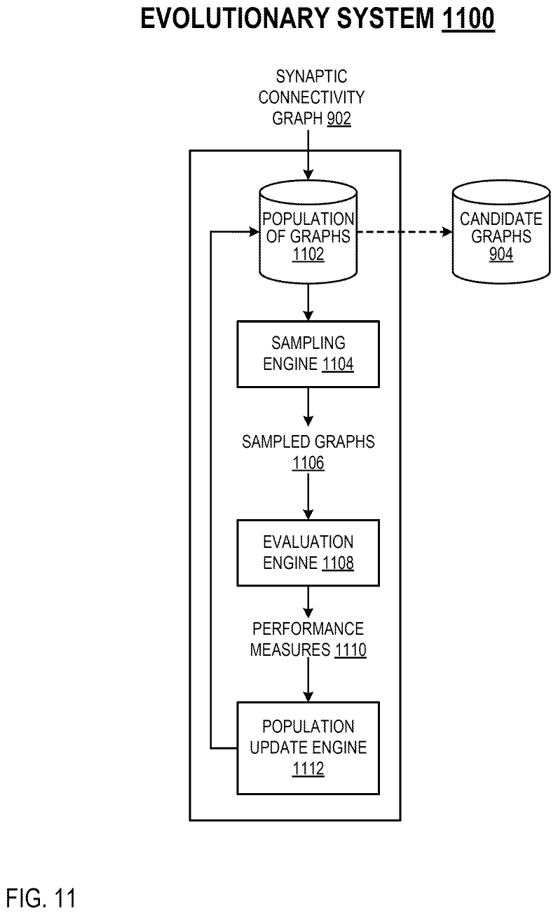

In another example, the architecture search system 900 may use an optimization system 1100 to generate the set of candidate graphs 904 from the synaptic connectivity graph 902. An example optimization system 1100 is described in more detail with reference to FIG. 11.

In some cases, some or all of the candidate graphs 904 are sub-graphs of the synaptic connectivity graph. For example, some or all of the candidate graphs 904 can be randomly selected sub-graphs, e.g., that are generated by randomly selecting a proper subset of the rows and a proper subset of the columns of the adjacency matrix representing the synaptic connectivity graph that define a sub-matrix of the adjacency matrix. The sub-graph may include: (i) each edge specified by the sub-matrix, and (ii) each node that is connected by an edge specified by the sub-matrix.

The architecture search system 900 uses the evaluation engine 906 to determine a respective performance measure 912 for each candidate graph 904. The evaluation engine 906 may determine the performance measure 912 for a candidate graph 904 based on a performance measure on a semantic segmentation task of a segmentation neural network having a brain emulation sub-network with a neural network architecture specified by the candidate graph 904. The architecture search system 900 may map each candidate graph 904 to a corresponding brain emulation sub-network architecture, e.g., using the architecture mapping engine described with reference to FIG. 8.

The evaluation engine 906 may measure the performance of a segmentation neural network on a semantic segmentation task, e.g., by training the segmentation neural network on a set of training data 910, and then evaluating the performance of the trained segmentation neural network on a set of validation data 908. Both the training data 910 and the validation data 908 may include training examples, where each training example specifies: (i) an image, and (ii) a target segmentation of the image. In determining the performance measure of a segmentation neural network, the evaluation engine 906 trains the segmentation neural network on the training data 910, but reserves the validation data 908 for evaluating the performance of the trained segmentation neural network (i.e., by not training the segmentation neural network on the validation data 908). The evaluation engine 906 may evaluate the performance of the trained neural network on the validation data 908, e.g., by using an objective function to measure an error between: (i) the target segmentations specified by the validation data, and (ii) the predicted segmentations generated by the trained segmentation neural network. The objective function may be, e.g., a squared-error objective function.

In determining the performance measure 912 for a candidate graph 904, the evaluation engine 906 may take other factors into consideration in addition to the performance of the segmentation neural network that includes the brain emulation sub-network specified by the candidate graph 904 on the semantic segmentation task. For example, the evaluation engine 906 may further determine the performance measure 912 for a candidate graph 904 based on the computational resource consumption of a segmentation neural network that includes a brain emulation sub-network specified by the candidate graph. The computational resource consumption corresponding to a neural network architecture may be determined based on, e.g.: (i) the memory required to store data specifying the architecture, and (ii) the number of arithmetic operations performed by a neural network having the architecture to generate a network output. In one example, the evaluation engine 906 may determine the performance measure 912 of each candidate graph as a linear combination of: (i) a performance measure of a segmentation neural network that includes a brain emulation sub-network specified by the candidate graph on a semantic segmentation task, and (ii) a measure of the computational resource consumption induced by the segmentation neural network.

The architecture search system 900 may identify a best-performing graph 914 based on the performance measures 912. For example, the architecture search system 900 may identify the best-performing graph 914 as the candidate graph 904 with the highest performance measure 912.

After identifying the best-performing graph 914 from the set of candidate graphs 904, the architecture search system 900 may provide the brain emulation sub-network 916 specified by the best-performing graph 914 for use as part of a segmentation neural network that performs a semantic segmentation task.

FIG. 10 shows an example constraint satisfaction system 1000. The constraint satisfaction system 1000 is an example of a system implemented as computer programs on one or more computers in one or more locations in which the systems, components, and techniques described below are implemented.

The constraint satisfaction system 1000 is configured to generate a set of candidate graphs 904 based on “constraints” derived from the values of graph features characterizing the synaptic connectivity graph 902. The candidate graphs 904 generated by the constraint satisfaction system 1000 each specify a neural network architecture that may be provided to the architecture search system described with reference to FIG. 9.

The constraint satisfaction system 1000 generates the candidate graphs 904 from the synaptic connectivity graph 902 using a feature generation engine 1002 and a graph update engine 1008, each of which will be described in more detail next.

The feature generation engine 1002 is configured to process the synaptic connectivity graph 902 to determine the values of one or more graph features 1004 of the synaptic connectivity graph 902, e.g., that characterize various aspects of the structure of the synaptic connectivity graph 902. A few examples of graph features follow.

In one example, the feature generation engine 1002 may determine a graph feature value 1004 that specifies the number of nodes in the synaptic connectivity graph 902.

In another example, the feature generation engine 1002 may determine a graph feature value 1004 that specifies the number of edges in the largest cluster in a two-dimensional array representing the synaptic connectivity graph 902. A cluster in a two-dimensional array representing a graph may refer to a contiguous region of the array such that at least a threshold fraction of the components in the region have a value indicating that an edge exists between the pair of nodes corresponding to the component.

In another example, the feature generation engine 1002 may determine a graph feature value 1004 that specifies the number of clusters in the two-dimensional array representing the synaptic connectivity graph 902 that include a number of edges that is within a predefined range of values, e.g., the range [5,10].

In another example, the feature generation engine 1002 may determine graph feature values 1004 that specify, for each of multiple predefined ranges of values, the number of clusters in the two-dimensional array representing the synaptic connectivity graph that include a number of edges that is within the range of values. The predefined ranges of values may be, e.g.: {[1,10], [10,100], [100, ∞)}.

In another example, the feature generation engine 1002 may determine a graph feature value 1004 that specifies the average path length between nodes in the synaptic connectivity graph 902.

In another example, the feature generation engine 1002 may determine a graph feature value 1004 that specifies the maximum path length between nodes in the synaptic connectivity graph 902.

In another example, the feature generation engine 1002 may determine a graph feature value 1004 that specifies the fraction of node pairs in the synaptic connectivity graph 902 (i.e., where a node pair specifies a first node and a second node in the synaptic connectivity graph 902) that are connected by an edge.

In another example, the feature generation engine 1002 may determine a graph feature value 1004 that specifies the fraction of nodes in the synaptic connectivity graph 902 having the property that the synaptic connectivity graph 902 includes an edge that connects the node to itself.

The constraint satisfaction system 1000 determines one or more constraints 1006 from the graph features values 1004 characterizing the synaptic connectivity graph 902. Each constraint corresponds to a respective graph feature and specifies a target value or a range of target values of the graph feature for the candidate graphs 904. A few examples of determining constraints from the graph feature values 1004 characterizing the synaptic connectivity graph 902 are described next.

In one example, the constraint satisfaction system 1000 may determine a constraint specifying a target value for a graph feature for the candidate graphs 904 that matches the value of the graph feature for the synaptic connectivity graph 902. For example, if the value of the graph feature specifying the number of nodes in the synaptic connectivity graph 902 is n, then the constraint satisfaction system 1000 may determine the target value of the graph feature specifying the number of nodes in each candidate graph 904 to be n.

As another example, the constraint satisfaction system 1000 may determine a constraint specifying a range of target values for a graph feature for the candidate graphs 904, where the range of target values includes the value of the graph feature for the synaptic connectivity graph 902. In one example, the value of the graph feature specifying the fraction of node pairs in the synaptic connectivity graph 902 that are connected by an edge may be p∈(0,1). In this example, the constraint satisfaction system 1000 may determine the target range of values of the graph feature specifying the fraction of node pairs in each candidate graph 904 that are connected by an edge to be [p−ε, p+ε]∩[0,1], where ε>0.

The graph update engine 1008 uses the constraints 1006 to guide a procedure for randomly generating candidate graphs 904, e.g., to cause each of the candidate graphs 904 to satisfy at least one of the constraints 1006. For example, the graph update engine 1008 may generate a candidate graph 904 by iteratively updating an “initial” graph 1010, e.g., by adding or removing nodes or edges from the initial graph 1010 at each of one or more iterations. The initial graph 1010 may be, e.g., a default (predefined) graph, or a randomly generated graph. At each iteration, the graph update engine 1008 may update the current graph to cause the current graph to satisfy a corresponding constraint 1006. For example, the constraints 1006 may be associated with a predefined linear ordering {Cᵢ}ᵢ₌₀^{N-1} (i.e., where each Cᵢ denotes a constraint), and at the j-th iteration, the graph update engine 1008 may update the current graph to cause it to satisfy constraint C_{(j mod N)}. Put another way: at the first iteration, the graph update engine 1008 may update the initial graph to cause it to satisfy the first constraint; at the second iteration, the graph update engine 1008 may update the current graph to cause it to satisfy the second constraint; and so on. After updating the current graph to cause it to satisfy the final constraint, the graph update engine 1008 may loop back to the first constraint. After a final iteration (e.g., of a predefined number of iterations), the graph update engine 1008 may output the current graph as a candidate graph 904.

At any given iteration, the graph update engine 1008 may update the current graph to satisfy a corresponding constraint 1006 using a procedure that involves some randomness. In one example, the graph update engine 1008 may update the current graph to satisfy a constraint specifying that the fraction of node pairs in the graph that are connected by an edge be p∈(0,1). In this example, the graph update engine 1008 may randomly add or remove edges from the current graph until the constraint is satisfied. In another example, the graph update engine 1008 may update the current graph to satisfy a constraint specifying that the graph include N clusters that each have a number of edges that is included in the interval [A, B]. For convenience, this example will assume that the current graph is a default graph that does not yet include any edges. The graph update engine 1008 may randomly select N locations in a representation of the graph as a two-dimensional array having value 0 in each component, e.g., by sampling N locations from a uniform distribution over the array. For each of the N sampled locations in the array, the graph update engine 1008 may identify a contiguous region around the location that includes a number of components in the range [A, B], and then set each component in the contiguous region to have value 1 (i.e., indicating an edge).

In some cases, a candidate graph 904 generated by the graph update engine 1008 may not satisfy all of the constraints. In particular, at one or more iterations during generation of the candidate graph, updating the current graph to cause it to satisfy a corresponding constraint 1006 may have resulted in the updated graph violating one or more other constraints.

FIG. 11 shows an example evolutionary system 1100. The evolutionary system 1100 is an example of a system implemented as computer programs on one or more computers in one or more locations in which the systems, components, and techniques described below are implemented.

The evolutionary system 1100 is configured to generate a set of candidate graphs 904 from the synaptic connectivity graphb 902 by evolving a population (i.e., set) of graphs 1102 derived from the synaptic connectivity graph 902 over multiple evolutionary iterations. The candidate graphs 904 generated by the evolutionary system 1100 each specify a neural network architecture that may be provided to the architecture search system described with reference to FIG. 9.

At each evolutionary iteration, the evolutionary system 1100 may adapt the population of graphs 1102 by removing one or more graphs from the population 1102, adding one or more graphs to the population 1102, or changing one or more graphs in the population 1102. As will be described in more detail below, the changes applied to the population of graphs at each iteration include an element of randomness and are intended to increase the quality measures of the graphs in the population 1102. After a final evolutionary iteration, the evolutionary system 1100 may provide the current population of graphs 1102 as the set of candidate graphs 904.

Prior to the first evolutionary iteration, the evolutionary system 1100 may initialize the population 1102 based on the synaptic connectivity graph 902. For example, to initialize the population 1102, the evolutionary system 1100 may generate multiple copies of the synaptic connectivity graph 902, and “mutate” (i.e., modify) each copy of the synaptic connectivity graph 902 to generate a mutated graph which is then added to the initial population 1102. The evolutionary system 1100 may mutate a graph by applying one or more random modifications to the graph. The random modifications may include, e.g., adding or removing edges between randomly selected pairs of nodes in the graph, or adding random “noise” values (e.g., sampled from a predefined probability distribution) to the weight values associated with the edges of the graph.

At each evolutionary iteration, the sampling engine 1104 may select (e.g., randomly sample) a set of current graphs 1106 from the population of graphs 1102. The evolutionary system 1100 may use an evaluation engine 1108 (e.g., as described with reference to FIG. 9) to determine a respective performance measure 1110 corresponding to each of the sampled graphs 1106. The performance measure for a graph may be based on a performance on a semantic segmentation task of a segmentation neural network that includes a brain emulation sub-network having the neural network architecture specified by the graph.

The population update engine 1112 determines how the population of graphs 1102 should be updated at the current evolutionary iteration based on the performance measures 1110 of the sampled graphs 1106. For example, the population update engine 1112 may remove any sampled graphs 1106 having performance measures 1110 that are below a threshold value. As another example, for sampled graphs 1106 having performance measures that are above a threshold value, the population update engine 1112 may: (i) maintain the sampled graphs 1106 in the population 1102, and (ii) add randomly mutated (i.e., modified) copies of the sampled graphs 1106 to the population 1102.

Iteratively adapting the population of graphs 1102 in this manner simulates an evolutionary process by which graphs having desirable traits (e.g., that result in higher quality measures) are propagated and mutated in the population, and graphs having undesirable traits (i.e., that result in low quality measures) are removed from the population. Initializing the population of graphs 1102 using the synaptic connectivity graph 902 may facilitate the evolution of biologically-inspired graphs specifying neural network architectures are effective at performing machine learning tasks.

FIG. 12 shows an example optimization system 1200. The optimization system 1200 is an example of a system implemented as computer programs on one or more computers in one or more locations in which the systems, components, and techniques described below are implemented.

The optimization system 1200 generates candidate graphs 904 using a graph generation engine 1202. The graph generation engine 1202 is configured to process the synaptic connectivity graph 902 in accordance with a set of graph generation parameters 1212 to generate an output graph 1204 that is added to the set of candidate graphs 904. The optimization system 1200 iteratively optimizes the parameters 1212 of the graph generation engine 1202 using an optimization engine 1210 to increase the performance measures 1208 of the output graphs 1204 generated by the graph generation engine 1202, as will be described in more detail below.

The parameters 1212 of the graph generation engine 1202 specify transformation operations that are applied to the synaptic connectivity graph 902 to generate an output graph 1204. The graph generation engine 1202 may generate the output graph 1204 by applying transformation operations to a representation of the synaptic connectivity graph 902 as a two-dimensional array of numerical values. As described above, a graph may be represented as a two-dimensional array of numerical values with a number of rows and columns equal to the number of nodes in the graph. The component of the array at position (i,j) may have value 1 if the graph includes an edge pointing from node i to node j, and value 0 otherwise. In one example, as part of generating an output graph 1204, the graph generation engine 1202 may apply a convolutional filtering operation specified by a filtering kernel to the array representing the synaptic connectivity graph 902. In this example, the graph generation parameters 1212 may specify the components of a matrix defining the filtering kernel. In another example, as part of generating an output graph 1204, the graph generation engine 1202 may apply a “shifting” operation to the array representing the synaptic connectivity graph 902, e.g., such that each the value in each component of the array is translated “left”, “right”, “up”, or “down”. Components that are shifted outside the bounds of the array may be wrapped around the opposite side of the array. In this example, the graph generation parameters 1212 may specify the direction and magnitude of the shifting operation. In another example, as part of generating an output graph 1204, the graph generation engine 1202 may remove one or more nodes from the synaptic connectivity graph, e.g., such that the output graph is a sub-graph of the synaptic connectivity graph. In this example, the graph generation parameters 1212 may specify the nodes to be removed from the synaptic connectivity graph 902 (e.g., the graph generation parameters 1212 may specify the indices of the nodes to be removed from the synaptic connectivity graph 902).

At each of multiple iterations, the graph generation engine 1202 processes the synaptic connectivity graph 902 in accordance with the current values of the graph generation parameters 1212 to generate an output graph 1204 which may then be added to the set of candidate graphs 904. The optimization system 1200 determines a performance measure 1208 of the output graph 1204 using an evaluation engine 1206 (e.g., as described with reference to FIG. 9), and then provides the performance measure 1208 of the output graph 1204 to the optimization engine 1210.

The optimization engine 1210 is configured to process the performance measures 1208 of the output graphs 1204 to determine adjustments to the current values of the graph generation parameters to encourage the generation of output graphs with higher performance measures. Prior to the first iteration, the values of the graph generation parameters 1212 may be set to default values or randomly initialized. The optimization engine 1210 may use any appropriate optimization technique, e.g., a “black-box” optimization technique that does not rely on computing gradients of the transformation operations applied by the graph generation engine 1202. Examples of black-box optimization techniques which may be implemented by the optimization engine 846 are described with reference to: Golovin, D., Solnik, B., Moitra, S., Kochanski, G., Karro, J., & Sculley, D.: “Google vizier: A service for black-box optimization,” In Proceedings of the 23rd ACM SIGKDD International Conference on Knowledge Discovery and Data Mining, pp. 1487-1495 (2017).

After the final iteration, the optimization system 1200 may provide the candidate graphs 904 for use by the architecture search system 900 described with reference to FIG. 9.

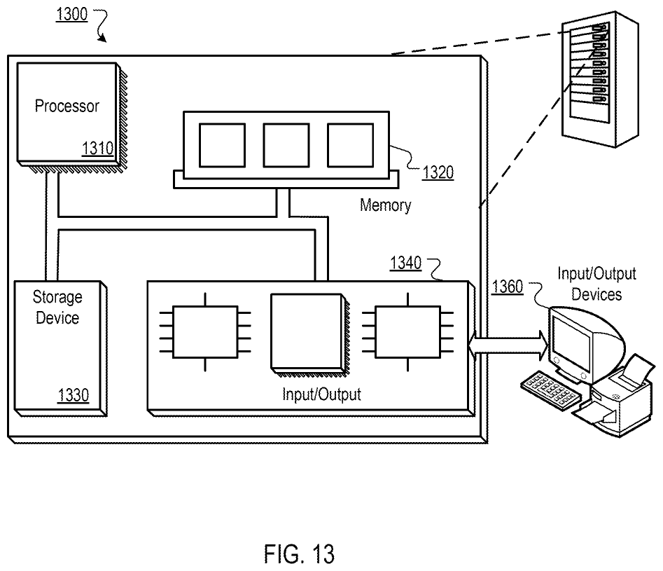

FIG. 13 is a block diagram of an example computer system 1300 that can be used to perform operations described previously. The system 1300 includes a processor 1310, a memory 1320, a storage device 1330, and an input/output device 1340. Each of the components 1310, 1320, 1330, and 1340 can be interconnected, for example, using a system bus 1350. The processor 1310 is capable of processing instructions for execution within the system 1300. In one implementation, the processor 1310 is a single-threaded processor. In another implementation, the processor 1310 is a multi-threaded processor. The processor 1310 is capable of processing instructions stored in the memory 1320 or on the storage device 1330.

The memory 1320 stores information within the system 1300. In one implementation, the memory 1320 is a computer-readable medium. In one implementation, the memory 1320 is a volatile memory unit. In another implementation, the memory 1320 is a non-volatile memory unit.

The storage device 1330 is capable of providing mass storage for the system 1300. In one implementation, the storage device 1330 is a computer-readable medium. In various different implementations, the storage device 1330 can include, for example, a hard disk device, an optical disk device, a storage device that is shared over a network by multiple computing devices (for example, a cloud storage device), or some other large capacity storage device.

The input/output device 1340 provides input/output operations for the system 1300. In one implementation, the input/output device 1340 can include one or more network interface devices, for example, an Ethernet card, a serial communication device, for example, and RS-232 port, and/or a wireless interface device, for example, and 802.11 card. In another implementation, the input/output device 1340 can include driver devices configured to receive input data and send output data to other input/output devices, for example, keyboard, printer and display devices 1360. Other implementations, however, can also be used, such as mobile computing devices, mobile communication devices, and set-top box television client devices.

Although an example processing system has been described in FIG. 13, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

According to a first aspect, there is provided a method performed by one or more data processing apparatus for training a segmentation neural network, the method comprising: obtaining data defining: (i) an image, and (ii) a respective class of each pixel in the image from a set of possible classes; determining a target segmentation of the image that comprises one or more target contrastive channels, wherein each target contrastive channel corresponds to a respective pair of classes including a respective first class and a respective second class from the set of possible classes, wherein each target contrastive channel comprises a respective score for each pixel in the image that defines whether the pixel is included in: (i) the first class corresponding to the target contrastive channel, (ii) the second class corresponding to the target contrastive channel, or (iii) any class other than the first class or the second class corresponding to the target contrastive channel; and training the segmentation neural network to process the image to generate a predicted segmentation that matches the target segmentation.

In some implementations, for each target contrastive channel, the respective score for each pixel has a first value if the pixel is included in the first class corresponding to the target contrastive channel, a second value if the pixel is included in the second class corresponding to the target contrastive channel, and a third value if the pixel is included in any class other than the first class or the second class corresponding to the target contrastive channel.

In some implementations, an activation function in an output layer of the segmentation neural network is a tanh activation function, and wherein the first value is −1, the second value is +1, and the third value is 0.

In some implementations, an activation function in an output layer of the segmentation neural network is a sigmoid activation function, and wherein the first value is 0, the second value is +1, and the third value is 0.5.

In some implementations, the target segmentation output comprises a plurality of target contrastive channels, wherein each target contrastive channel corresponds to a respective pair of classes that includes a same base class from the set of possible classes.

In some implementations, the base class is a class that occurs most frequently in a set of training data that is used for training the segmentation neural network.

In some implementations, each target channel in the target segmentation output is a target contrastive channel, and a number of target channels in the target segmentation output is half or less of a number of classes in the set of possible classes.

In some implementations, training the segmentation neural network to process the image to generate an output that matches the target segmentation output comprises: processing the image using the segmentation neural network, in accordance with values of a plurality of segmentation neural network parameters, to generate a predicted segmentation output that comprises a respective predicted channel corresponding to each target channel in the target segmentation output; and updating the values of the plurality of segmentation neural network parameters using gradients of an objective function that measures an error between: (i) the predicted segmentation output, and (ii) the target segmentation output.

In some implementations, the method further comprises, after the training the segmentation neural network: receiving a new image; processing the new image using the trained segmentation neural network to generate a predicted segmentation of the new image, wherein the predicted segmentation comprises one or more predicted contrastive channels, wherein each predicted contrastive channel corresponds to a respective pair of classes including a respective first class and a respective second class, wherein each predicted contrastive channel comprises a respective score for each pixel in the image that predicts whether the pixel is included in: (i) the first class corresponding to the predicted contrastive channel, (ii) the second class corresponding to the predicted contrastive channel, or (iii) any class other than the first class or the second class corresponding to the predicted contrastive channel; and processing the predicted segmentation of the new image to determine, for each pixel in the new image, a respective class from the set of possible classes that corresponds to the pixel.

In some implementations, the image is a satellite image, and wherein the set of possible classes includes one or more of: vegetation, buildings, water, or roads.

In some implementations, the segmentation neural network comprises a brain emulation sub-network having a brain emulation neural network architecture that is based on synaptic connectivity between biological neurons in a brain of a biological organism.

In some implementations, the brain emulation neural network architecture is determined from a synaptic connectivity graph that represents the synaptic connectivity between the biological neurons in the brain of the biological organism.

In some implementations, the synaptic connectivity graph comprises a plurality of nodes and edges, each edge connects a pair of nodes, each node corresponds to a respective neuron in the brain of the biological organism, and each edge connecting a pair of nodes in the synaptic connectivity graph corresponds to a synaptic connection between a pair of biological neurons in the brain of the biological organism.

In some implementations, the synaptic connectivity graph is generated by a plurality of operations comprising: obtaining a synaptic resolution image of at least a portion of the brain of the biological organism; and processing the image to identify: (i) a plurality of neurons in the brain, and (ii) a plurality of synaptic connections between pairs of neurons in the brain.

In some implementations, determining the brain emulation neural network architecture from the synaptic connectivity graph comprises: mapping each node in the synaptic connectivity graph to a corresponding artificial neuron in the brain emulation neural network architecture; and mapping each edge in the synaptic connectivity graph to a connection between a corresponding pair of artificial neurons in the brain emulation neural network architecture.

In some implementations, determining the brain emulation neural network architecture from the synaptic connectivity graph further comprises: instantiating a respective parameter value associated with each connection between a pair of artificial neurons in the brain emulation neural network architecture that is based on a respective proximity between a corresponding pair of biological neurons in the brain of the biological organism.

In some implementations, determining the brain emulation neural network architecture from the synaptic connectivity graph comprises: generating data defining a plurality of candidate graphs based on the synaptic connectivity graph; determining, for each candidate graph, a performance measure on a semantic segmentation task of an instance of a segmentation neural network having a sub-network with an architecture that is specified by the candidate graph; and selecting the brain emulation neural network architecture based on the performance measures.

In some implementations, selecting the brain emulation neural network architectures based on the performance measures comprises: identifying a best-performing candidate graph that is associated with a highest performance measure from among the plurality of candidate graphs; and selecting the brain emulation neural network architecture to be an artificial neural network architecture specified by the best-performing candidate graph.

According to another aspect there is provided a system comprising: one or more computers; and one or more storage devices communicatively coupled to the one or more computers, wherein the one or more storage devices store instructions that, when executed by the one or more computers, cause the one or more computers to perform the operations of the methods described herein.

According to another aspect there are provided one or more non-transitory computer storage media storing instructions that when executed by one or more computers cause the one or more computers to perform the operations of the methods described herein.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more data processing apparatus for training a segmentation neural network, the method comprising:
obtaining data defining: (i) an image, and (ii) a respective class of each pixel in the image from a set of possible classes;
determining a target segmentation of the image that comprises one or more target contrastive channels,
wherein each target contrastive channel corresponds to a respective pair of classes including a respective first class and a respective second class from the set of possible classes,
wherein each target contrastive channel comprises a respective score for each pixel in the image that defines whether the pixel is included in: (i) the first class corresponding to the target contrastive channel, (ii) the second class corresponding to the target contrastive channel, or (iii) any class other than the first class or the second class corresponding to the target contrastive channel; and
training the segmentation neural network to process the image to generate a predicted segmentation that matches the target segmentation.

2. The method of claim 1, wherein for each target contrastive channel, the respective score for each pixel has a first value if the pixel is included in the first class corresponding to the target contrastive channel, a second value if the pixel is included in the second class corresponding to the target contrastive channel, and a third value if the pixel is included in any class other than the first class or the second class corresponding to the target contrastive channel.

3. The method of claim 2, wherein an activation function in an output layer of the segmentation neural network is a tanh activation function, and wherein the first value is −1, the second value is +1, and the third value is 0.

4. The method of claim 2, wherein an activation function in an output layer of the segmentation neural network is a sigmoid activation function, and wherein the first value is 0, the second value is +1, and the third value is 0.5.

5. The method of claim 1, wherein the target segmentation output comprises a plurality of target contrastive channels, wherein each target contrastive channel corresponds to a respective pair of classes that includes a same base class from the set of possible classes.

6. The method of claim 5, wherein the base class is a class that occurs most frequently in a set of training data that is used for training the segmentation neural network.

7. The method of claim 1, wherein each target channel in the target segmentation output is a target contrastive channel, and a number of target channels in the target segmentation output is half or less of a number of classes in the set of possible classes.

8. The method of claim 1, wherein training the segmentation neural network to process the image to generate an output that matches the target segmentation output comprises:
processing the image using the segmentation neural network, in accordance with values of a plurality of segmentation neural network parameters, to generate a predicted segmentation output that comprises a respective predicted channel corresponding to each target channel in the target segmentation output; and
updating the values of the plurality of segmentation neural network parameters using gradients of an objective function that measures an error between: (i) the predicted segmentation output, and (ii) the target segmentation output.

9. The method of claim 1, further comprising, after the training the segmentation neural network:
receiving a new image;
processing the new image using the trained segmentation neural network to generate a predicted segmentation of the new image, wherein the predicted segmentation comprises one or more predicted contrastive channels,
wherein each predicted contrastive channel corresponds to a respective pair of classes including a respective first class and a respective second class,
wherein each predicted contrastive channel comprises a respective score for each pixel in the image that predicts whether the pixel is included in: (i) the first class corresponding to the predicted contrastive channel, (ii) the second class corresponding to the predicted contrastive channel, or (iii) any class other than the first class or the second class corresponding to the predicted contrastive channel; and
processing the predicted segmentation of the new image to determine, for each pixel in the new image, a respective class from the set of possible classes that corresponds to the pixel.

10. The method of claim 1, wherein the image is a satellite image, and wherein the set of possible classes includes one or more of: vegetation, buildings, water, or roads.

11. The method of claim 1, wherein the segmentation neural network comprises a brain emulation sub-network having a brain emulation neural network architecture that is based on synaptic connectivity between biological neurons in a brain of a biological organism.

12. The method of claim 11, wherein the brain emulation neural network architecture is determined from a synaptic connectivity graph that represents the synaptic connectivity between the biological neurons in the brain of the biological organism.

13. The method of claim 12, wherein the synaptic connectivity graph comprises a plurality of nodes and edges, each edge connects a pair of nodes, each node corresponds to a respective neuron in the brain of the biological organism, and each edge connecting a pair of nodes in the synaptic connectivity graph corresponds to a synaptic connection between a pair of biological neurons in the brain of the biological organism.

14. The method of claim 13, wherein the synaptic connectivity graph is generated by a plurality of operations comprising:
obtaining a synaptic resolution image of at least a portion of the brain of the biological organism; and
processing the image to identify: (i) a plurality of neurons in the brain, and (ii) a plurality of synaptic connections between pairs of neurons in the brain.

15. The method of claim 13, wherein determining the brain emulation neural network architecture from the synaptic connectivity graph comprises:
mapping each node in the synaptic connectivity graph to a corresponding artificial neuron in the brain emulation neural network architecture; and
mapping each edge in the synaptic connectivity graph to a connection between a corresponding pair of artificial neurons in the brain emulation neural network architecture.

16. The method of claim 15, wherein determining the brain emulation neural network architecture from the synaptic connectivity graph further comprises:
instantiating a respective parameter value associated with each connection between a pair of artificial neurons in the brain emulation neural network architecture that is based on a respective proximity between a corresponding pair of biological neurons in the brain of the biological organism.

17. The method of claim 13, wherein determining the brain emulation neural network architecture from the synaptic connectivity graph comprises:
generating data defining a plurality of candidate graphs based on the synaptic connectivity graph;
determining, for each candidate graph, a performance measure on a semantic segmentation task of an instance of a segmentation neural network having a sub-network with an architecture that is specified by the candidate graph; and
selecting the brain emulation neural network architecture based on the performance measures.

18. The method of claim 17, wherein selecting the brain emulation neural network architectures based on the performance measures comprises:
identifying a best-performing candidate graph that is associated with a highest performance measure from among the plurality of candidate graphs; and
selecting the brain emulation neural network architecture to be an artificial neural network architecture specified by the best-performing candidate graph.

19. A system comprising:
one or more computers; and
one or more storage devices communicatively coupled to the one or more computers, wherein the one or more storage devices store instructions that, when executed by the one or more computers, cause the one or more computers to perform operations for training a segmentation neural network, the operations comprising:
obtaining data defining: (i) an image, and (ii) a respective class of each pixel in the image from a set of possible classes;
determining a target segmentation of the image that comprises one or more target contrastive channels,
wherein each target contrastive channel corresponds to a respective pair of classes including a respective first class and a respective second class from the set of possible classes,
wherein each target contrastive channel comprises a respective score for each pixel in the image that defines whether the pixel is included in: (i) the first class corresponding to the target contrastive channel, (ii) the second class corresponding to the target contrastive channel, or (iii) any class other than the first class or the second class corresponding to the target contrastive channel; and
training the segmentation neural network to process the image to generate a predicted segmentation that matches the target segmentation.

20. One or more non-transitory computer storage media storing instructions that when executed by one or more computers cause the one or more computers to perform operations for training a segmentation neural network, the operations comprising:
obtaining data defining: (i) an image, and (ii) a respective class of each pixel in the image from a set of possible classes;
determining a target segmentation of the image that comprises one or more target contrastive channels,
wherein each target contrastive channel corresponds to a respective pair of classes including a respective first class and a respective second class from the set of possible classes,
wherein each target contrastive channel comprises a respective score for each pixel in the image that defines whether the pixel is included in: (i) the first class corresponding to the target contrastive channel, (ii) the second class corresponding to the target contrastive channel, or (iii) any class other than the first class or the second class corresponding to the target contrastive channel; and
training the segmentation neural network to process the image to generate a predicted segmentation that matches the target segmentation.
